(19) United States
(12) Patent Application Publication
(10) Pub. No.: US 2026/0219621 A1
(43) Pub. Date: Jul. 30, 2026

(54) DETECTING UNIT AND IMAGE FORMING APPARATUS

(71) Applicant: BROTHER KOGYO KABUSHIKI KAISHA, Nagoya (JP)

(72) Inventors: MIKIO INUZUKA, Okazaki (JP); SHUJI KAWASAKI, Nagoya (JP)

(73) Assignee: BROTHER KOGYO KABUSHIKI KAISHA, Nagoya (JP)

(21) Appl. No.: 19/456,271

(22) Filed: Jan. 22, 2026

(30) Foreign Application Priority Data
Jan. 27, 2025 (JP) 2025-011039

(51) Int. Cl. G03G 15/00; G01N 21/55

(52) U.S. Cl. CPC G03G 15/5058; G01N 21/55; G03G 15/80; G01N 2021/555; G03G 2215/00059

(57) ABSTRACT

A detecting unit for an image forming apparatus configured to form a toner image on an image carrier, includes: a first sensor including a first substrate; a second sensor including a second substrate; a first cable harness including first wires corresponding to the first sensor; and a second cable harness including second wires corresponding to the first sensor and wires corresponding to the second sensor. The first and second sensors are configured to detect a mark image formed in first and second areas of the image carrier, respectively. First and second ends of the first cable harness is connected to the first and second substrates, respectively. A first end of the second cable harness is connected to the second substrate, and a second end of the second cable harness is connectable to a controller. The second substrate includes relay wiring patterns connecting the first wires and the second wires.

### REFERENCE TO RELATED APPLICATIONS

This application claims priority from Japanese Patent Application No. 2025-011039 filed on January 27, 2025. The entire content of the priority application is incorporated herein by reference.

### BACKGROUND ART

A detecting unit used in an image forming apparatus that forms an image on a belt with components such as a developing roller and a photosensitive drum is known. The known detecting unit includes a front optical sensor, a rear optical sensor, and a cable harness.

The front optical sensor is disposed facing an area located on one side of the belt in a width direction, and detects a mark image formed in the area. The rear optical sensor is disposed facing an area located on the other side of the belt in the width direction, and detects a mark image formed in the area.

The cable harness has, at one end, two branch ends connected to the front optical sensor and the rear optical sensor, and the other end of the cable harness is connected to a control board. The cable harness transmits detection results of the front optical sensor and the rear optical sensor to the control board. Based on the detection results, the control board performs density correction and color shift correction during image formation.

### SUMMARY

In the known detecting unit described above, the cable harness is branched at the one end, which may result in a relatively long total length, thus hindering the simplification of routing (hereinafter, referred as "routing operation") and increasing parts costs.

The present disclosure is made in view of the above situation and aims to provide a detecting unit and an image forming apparatus capable of achieving simplification of routing operation of a first cable harness and a second cable harness, and reduction of parts costs.

An aspect of the present disclosure is a detecting unit for an image forming apparatus configured to form a toner image on an image carrier. The detecting unit includes: a first sensor including a first substrate, the first sensor being disposed on a first side in a particular direction of the detecting unit, the particular direction corresponding to a width direction of the image carrier; a second sensor including a second substrate, the second sensor being disposed on a second side, which is opposite to the first side, in the particular direction; a first cable harness including a plurality of first wires corresponding to the first sensor; and a second cable harness including a plurality of second wires corresponding to the first sensor and a plurality of wires corresponding to the second sensor. The first sensor is configured to detect a mark image formed in a first area of the image carrier by emitting a first light to the first area and receiving the first light reflected from the first area, the first area being located on a first side in the width direction of the image carrier. The second sensor is configured to detect a mark image formed in a second area of the image carrier by emitting a second light to the second area and receiving the second light reflected from the second area, the second area being located on a second side, opposite to the first side, in the width direction of the image carrier. The first cable harness has a first end and a second end opposite to each other, the first end of the first cable harness being connected to the first substrate, and the second end of the first cable harness being connected to the second substrate. The second cable harness has a first end and a second end opposite to each other. the first end of the second cable harness being connected to the second substrate, and the second end of the second cable harness being connectable to a controller of the image forming apparatus. The second substrate includes a plurality of relay wiring patterns connecting the plurality of first wires and the plurality of second wires.

In the detecting unit of the present disclosure, the plurality of relay wiring patterns formed on the second substrate connects the plurality of first wires corresponding to the first sensor of the first cable harness to the plurality of second wires corresponding to the first sensor of the second cable harness to relay the detecting result of the first sensor. With this configuration, the length of the first cable harness can be shortened in the detecting unit. As a result, the total length of the first cable harness and the second cable harness can be shortened in the detecting unit.

Therefore, in the detecting unit of the present disclosure, the routing operation for the first cable harness and the second cable harness can be simplified, and parts costs can be reduced.

An aspect of the present disclosure is an image forming apparatus including: a photosensitive drum; a developing roller; a belt on which a toner image is to be formed by the photosensitive drum; a control board; a first sensor including a first substrate, the first sensor being disposed facing a first area of the belt, the first area being located on a first side in a width direction of the belt; a second sensor including a second substrate, the second sensor being disposed facing a second area of the belt, the second area being located on a second side, opposite to the first side, in the width direction of the belt; a first cable harness including a plurality of first wires corresponding to the first sensor, the first cable harness having a first end and a second end opposite to each other, the first end of the first cable harness being connected to the first substrate, the second end of the first cable harness being connected to the second substrate; and a second cable harness including a plurality of second wires corresponding to the first sensor and a plurality of wires corresponding to the second sensor, the second cable harness having a first end and a second end opposite to each other, the first end of the second cable harness being connected to the second substrate, the second end of the second cable harness being connected to the control board of the image forming apparatus. The first sensor is configured to detect a mark image formed in the first area by emitting a first light to the first area and receiving the first light reflected from the first area. The second sensor is configured to detect a mark image formed in the second area by emitting a second light to the second area and receiving the second light reflected from the second area. The second substrate includes a plurality of relay wiring patterns connecting the plurality of first wires and the plurality of second wires.

In the image forming apparatus of the present disclosure, the routing operation for the first cable harness and the second cable harness can be simplified and parts cost can be reduced, as with the detecting unit of the present disclosure.

### BRIEF DESCRIPTION OF DRAWINGS

FIG. 1 is a schematic cross-sectional view of an image forming apparatus.

FIG. 2 is a perspective view illustrating a belt unit, a detecting unit, and a controller.

FIG. 3 is a perspective view of the detecting unit.

FIG. 4 is a perspective view of the detecting unit.

FIG. 5 is a rear view of the detecting unit.

FIG. 6 is an exploded perspective view of the detecting unit.

FIG. 7 is an exploded perspective view of the detecting unit.

FIG. 8 is a cross-sectional view illustrating a cross section along VIII-VIII line of FIG. 5.

FIG. 9 is an enlarged partial cross-sectional view of main portions of FIG. 8.

FIG. 10 is a schematic view illustrating a circuit board used as a first substrate and a second substrate, and a flexible flat cable used as a first cable harness and a second cable harness.

FIG. 11 is a schematic view illustrating a circuit configuration of the detecting unit.

### DESCRIPTION

In the following, an embodiment of the present disclosure will be described with reference to the drawings.

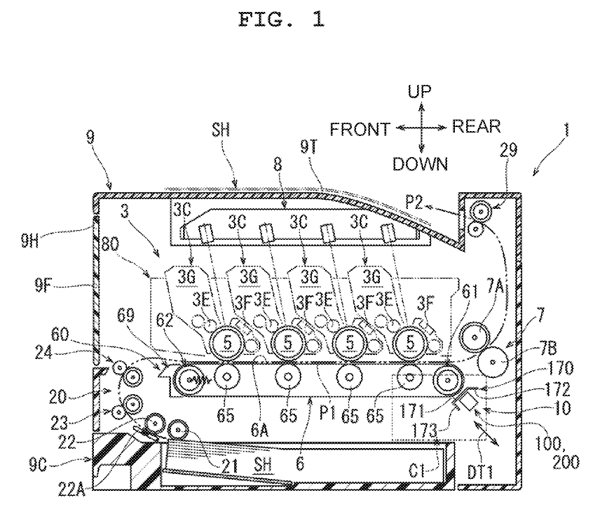

As illustrated in FIG. 1, an image forming apparatus 1 of the embodiment is an example of a specific aspect of an image forming apparatus of the present disclosure. The image forming apparatus 1 is a color printer that forms an image on a sheet in accordance with the electrophotography system.

A detecting unit 10 of the embodiment is an example of a specific aspect of a detecting unit of the present disclosure. The detecting unit 10 is used in the image forming apparatus 1. An overall configuration of the image forming apparatus 1 will be described first, and then the detecting unit 10 will be described in detail.

### Overall Configuration of Image Forming Apparatus

The image forming apparatus 1 includes a main body 9 having a substantially box-shaped structure. The image forming apparatus 1 further includes an image forming part 3, a sheet tray 9C, a feeding part 20, a discharge roller pair 29, and a controller C1 in the main body 9.

The sheet tray 9C is located below the image forming unit 3. The sheet tray 9C accommodates sheets SH in a stacked state before image formation. Examples of sheets SH include paper, OHP sheets, and similar materials.

A discharge tray 9T is defined on an upper surface of the main body 9. The discharge tray 9T supports a sheet SH on which an image has been formed.

The main body 9 has an opening 9H and a front cover 9F. The opening 9H is defined at an upper portion of a front surface of the main body 9. The front cover 9F is pivotable about a pivot axis at a lower end of the front cover 9F. The front cover 9F closes the opening 9H in a case where the front cover 9F is in an upright state, and exposes the opening 9H in a case where the front cover 9F is in a horizontal state. In response to the front cover 9F being pivoted such that an upper end of the front cover 9F moves downward to the front, the front cover 9F extends substantially horizontally and the upper end of the front cover 9F is oriented toward the front.

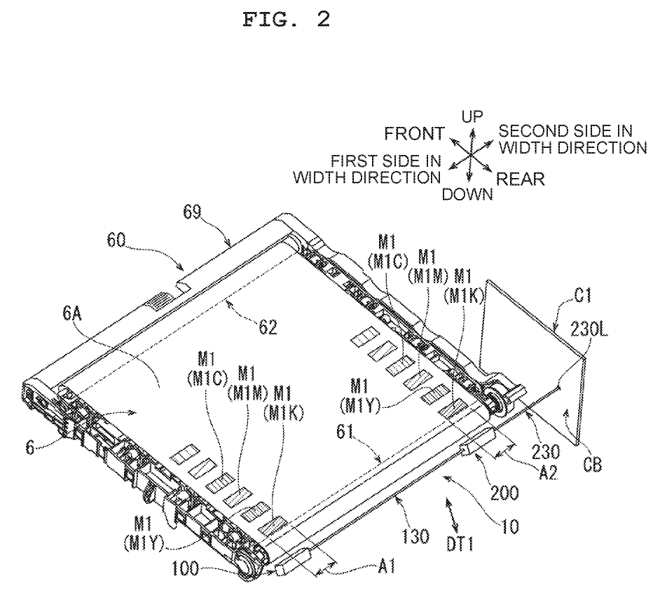

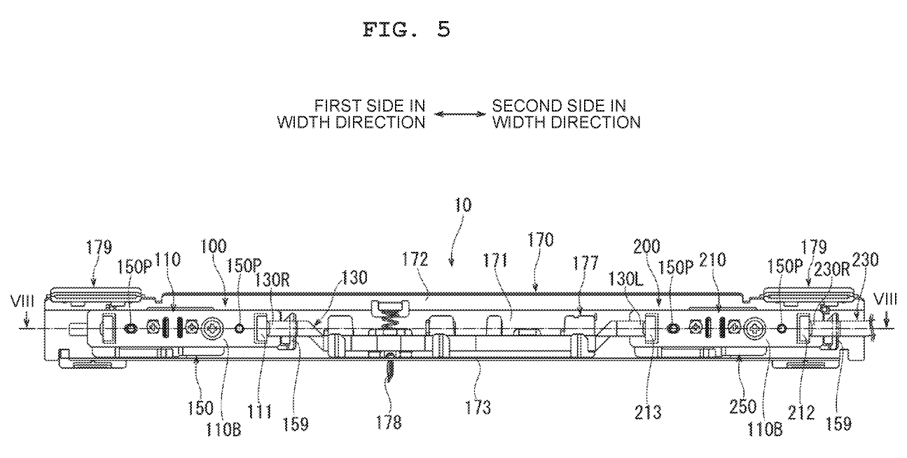

A width direction of the image forming apparatus 1 corresponds to a direction orthogonal to both a front-rear direction and an up-down direction. The side located on the left in a case where the opening 9H and the front cover 9F of the main body 9 are seen from the rear, i.e., the near side of the plane of the paper in FIG. 1, is defined as a first side in the width direction of the image forming apparatus 1. The side opposite to the first side in the width direction of the image forming apparatus 1 is defined as a second side. The front-rear direction, the up-down direction, and the width direction shown in FIG. 2 to FIG. 11 correspond to those in FIG. 1. The width direction of the image forming apparatus 1 corresponds to the width direction of a transfer belt 6 described below. The width direction is an example of a "particular direction" and a "width direction" of the present disclosure. The first side in the width direction is an example of a "first side" as well as a "second side" of the present disclosure. The second side in the width direction is an example of the "first side" as well as the "second side" of the present disclosure.

As illustrated in FIG. 1 and FIG. 2, the controller C1 is located near a rear surface of the main body 9 and near a side surface of the main body 9 on the second side in the width direction.

The controller C1 includes a control board CB, an operation part mainly including a CPU, a ROM, and a RAM (each not illustrated), and hardware configured to control, for example, a semiconductor laser and a motor. The ROM stores, for example, programs based on which the CPU controls various operations of the image forming apparatus 1, and programs for executing identification processing. The RAM functions as a memory area for temporarily recording data and signals used by the CPU when the CPU executes the above programs, or as a working area for data processing. The controller C1 controls the entire image forming apparatus 1, including the image forming part 3, the feeding part 20, and the discharge roller pair 29.

As illustrated in FIG. 1, the feeding part 20 is disposed forward of the image forming part 3. The feeding part 20 includes a feeding roller 21, a separating roller 22, a separating pad 22A, a conveying roller pair 23, and a registration roller pair 24 that are disposed along a feeding path P1.

The feeding path P1 extends frontward and upward from a front end of the sheet tray 9C, and is curved in a U-turn. The feeding path P1 then extends substantially horizontally toward the rear, passing through the image forming part 3.

The feeding roller 21 feeds a sheet SH to the feeding path P1 from the sheet tray 9C. In a case where multiple sheets SH are fed by the feeding roller 21, the separating roller 22 and separating pad 22A separate a single sheet SH from the multiple sheets SH.

The conveying roller pair 23 nips and conveys the sheet SH, separated by the separating roller 22 and separating pad 22A, toward the registration roller pair 24.

The registration roller pair 24 is located at a location where the feeding path P1 changes its direction. When the registration roller pair 24 is stationary, a leading edge of the sheet SH being conveyed toward the registration roller pair 24 comes into contact with the registration roller pair 24. After elapse of a predetermined time, the registration roller pair 24 starts rotating to convey the sheet SH toward the image forming part 3, thereby reducing skewing of the sheet SH.

The start of the rotation of the registration roller pair 24 is controlled based on timing at which an unillustrated sheet sensor, located at a position between the conveying roller pair 23 and the registration roller pair 24 in the feeding path P1, detects the leading edge of the sheet SH.

Then, the sheet SH, fed and conveyed to the image forming part 3 by the feeding part 20, travels through the image forming part 3 in a substantially horizontal portion of the feeding path P1.

The image forming part 3 performs image formation in accordance with a direct transfer type color electrophotographic system. The image forming part 3 includes a drawer 80, a belt unit 60, a scanner part 8, and a fuser 7.

The drawer 80 has a frame-like structure including a pair of side walls and a plurality of connecting parts. The side walls are respectively located on the near side and far side of the plane of the paper in FIG. 1 and extend in the front-rear direction. The connecting parts extend in the width direction and connect the side walls. The illustration of the drawer 80 is omitted since the drawer 80 has a known configuration.

The main body 9 accommodates the drawer 80. The drawer 80 contains four photosensitive drums 5 corresponding respectively to toners of four colors being black, yellow, magenta, and cyan. The drawer 80 supports the four photosensitive drums 5 so that each of the four photosensitive drums 5 can rotate about an axis extending in the width direction. The four photosensitive drums 5 are arranged in line in the front-rear direction along the substantially horizontal portion of the feeding path P1.

The drawer 80 supports four toner cartridges 3C. The toner cartridges 3C are provided for the photosensitive drums 5, respectively. The toner cartridges 3C are arranged in line in the front-rear direction along the substantially horizontal portion of the feeding path P1. Each toner cartridge 3C has a toner storage part 3G that stores toner of a corresponding color.

Each toner cartridge 3C includes a developing roller 3E and a charger 3F that are located around a corresponding photosensitive drum 5.

Although the illustration is omitted, when the front cover 9F exposes the opening 9H, the drawer 80 can be pulled out to a position in front of the main body 9, thereby allowing the drawer 80 to be detached from the main body 9. Detaching the drawer 80 from the main body 9 allows a user to perform a maintenance operation such as removal of a sheet SH jammed in the feeding path P1 or replacement of consumables.

As illustrated in FIG. 1 and FIG. 2, the belt unit 60 includes a unit frame 69, a driving roller 61, a driven roller 62, and a transfer belt 6. The transfer belt 6 is an example of an "image carrier".

The driving roller 61 is rotatably supported at a rear end of the unit frame 69. The driven roller 62 is rotatably supported at a front end of the unit frame 69.

The transfer belt 6 is an endless belt wrapped around the driving roller 61 and the driven roller 62. The transfer belt 6 has a conveying surface 6A. The conveying surface 6A is a portion of the transfer belt 6 which faces upward and which is defined between an upper end of the driving roller 61 and an upper end of the driven roller 62. The conveying surface 6A is a flat surface extending in the front-rear direction and the width direction.

As illustrated in FIG. 2, the controller C1 is located further toward the second side in the width direction than a side surface of the unit frame 69 located on the second side in the width direction.

As illustrated in FIG. 1, the belt unit 60 has four transfer rollers 65. Each transfer roller 65 is located between the driving roller 61 and the driven roller 62, and is rotatably supported by the unit frame 69. Each transfer roller 65 faces the corresponding photosensitive drum 5 from below, with the transfer belt 6 interposed between the transfer roller 65 and the corresponding photosensitive drum 5.

The conveying surface 6A of the transfer belt 6 is positioned below the photosensitive drums 5. The substantially horizontal portion of the feeding path P1 extends between the photosensitive drums 5 and the conveying surface 6A. The transfer belt 6 and the photosensitive drums 5 nip a sheet SH, which is conveyed by the conveying surface 6A, while the transfer belt 6 circulates.

Although the illustration is omitted, while the drawer 80 is not in the main body 9 and the front cover 9F exposes the opening 9H, a front end of the belt unit 60 can be lifted and the belt unit 60 can be diagonally pulled out toward the front, thereby allowing the belt unit 60 to be detached from the main body 9. Detaching the belt unit 60 allows the user to perform maintenance operations on the belt unit 60 and its surroundings.

The scanner part 8 is located above the photosensitive drums 5 and the toner cartridges 3C. The scanner part 8 includes, for example, a laser light source, a polygon mirror, an fθ lens, and a reflector. The scanner part 8 irradiates each of the photosensitive drums 5 with a laser beam from above.

In the drawer 80, the surface of each photosensitive drum 5 is thus uniformly and positively charged by a corresponding charger 3F as the photosensitive drum 5 rotates, and is then exposed to the laser beam emitted from the scanner part 8 by high-speed scanning. Thus, an electrostatic latent image is formed on the surface of each photosensitive drum 5. The electrostatic latent image corresponds to an image to be formed on the sheet SH.

Next, each developing roller 3E supplies toner, from a corresponding toner storage part 3G, onto the surface of the corresponding photosensitive drum 5 at an area where the electrostatic latent image has been formed, thereby forming a toner image. Then, the registration roller pair 24 conveys the sheet SH toward the photosensitive drums 5. As the sheet SH passes between each photosensitive drum 5 and the transfer belt 6, the upwardly-facing surface of the sheet SH faces each photosensitive drum 5. The toner image carried on the surface of each photosensitive drum 5 is thus transferred onto the upwardly-facing surface of the sheet SH.

The fuser 7 is located behind the drawer 80. The fuser 7 includes a heating roller 7A and a pressing roller 7B. In the fuser 7, the heating roller 7A and the pressing roller 7B apply heat and pressure to the sheet SH while nipping and conveying the sheet SH, thereby thermally fixing the toner images onto the sheet SH.

The discharge roller pair 29 is disposed at a downstream end of a discharge path P2. The discharge path P2 guides the sheet SH, which has passed through the fuser 7, upward and inverts the sheet SH so that the imaged surface faces downward, and then allow the sheet SH to be discharged onto the discharge tray 9T. The discharge roller pair 29 discharges the sheet SH onto the discharge tray 9T while nipping the sheet SH being conveyed along the discharge path P2.

### Mark Image and Detecting Unit

As illustrated in FIG. 2, the image forming apparatus 1 forms a toner image for test, that is a mark image M1, on the conveying surface 6A of the transfer belt 6 using the image forming part 3.

More specifically, in order to perform density correction or color shift correction during image formation by the image forming apparatus 1, the controller C1 controls the image forming part 3 and other appropriate components to transfer mark images M1 (M1C, M1M, M1Y, and M1K) directly onto the conveying surface 6A of the transfer belt 6 circulating without conveying a sheet SH..

The mark image M1C corresponds to cyan, the mark image M1M corresponds to magenta, the mark image M1Y corresponds to yellow, and the mark image M1K corresponds to black.

Mark images M1 are formed in a first area A1 and a second area A2. The first area A1 is located on the first side of the transfer belt 6 in the width direction with respect to the center of the transfer belt 6. The second area A2 is located on the second side of the transfer belt 6 in the width direction with respect to the center of the transfer belt 6.

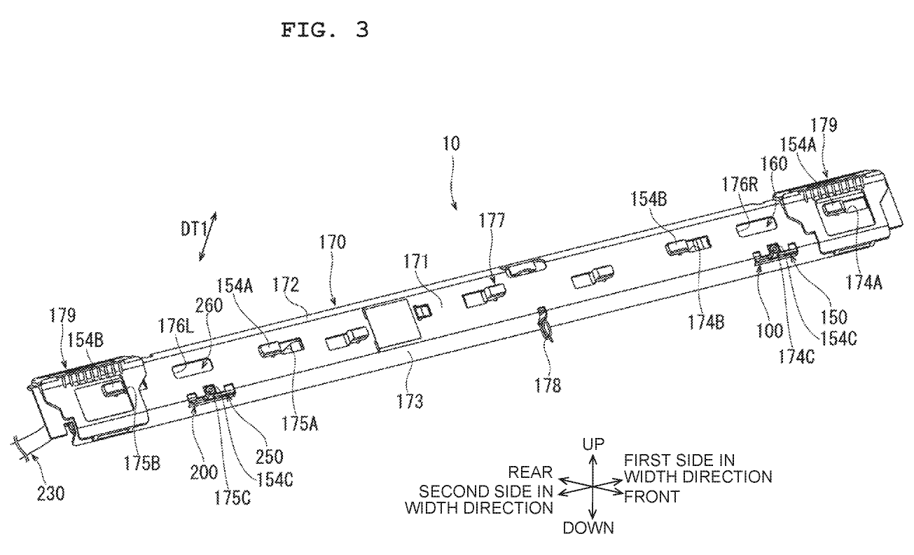

Then, the controller C1 causes the detecting unit 10 to detect the mark images M1. The detecting unit 10 includes a first sensor 100 being an optical sensor, a second sensor 200 being an optical sensor, a first cable harness 130, and a second cable harness 230. The specific configuration of the detecting unit 10 will be described in detail later with reference to FIG. 3 to FIG. 11.

As illustrated in FIG. 2, the first sensor 100 and the second sensor 200 are disposed below and to the rear of a particular portion of the transfer belt 6, wound around the driving roller 61. The first sensor 100 and the second sensor 200 are slightly spaced from the particular portion of the transfer belt 6.

The first sensor 100 is disposed facing the first area A1 of the transfer belt 6. The first sensor 100 detects the mark images M1 formed in the first area A1 by emitting light toward the first area A1 and receiving light reflected from the first area A1.

More specifically, the first sensor 100 detects a specular reflection component included in the light reflected from a "portion with a mark image M1" in the first area A1 and a specular reflection component included in the light reflected from a "portion without a mark image M1".

The second sensor 200 is disposed facing the second area A2 of the transfer belt 6. The second sensor 200 detects the mark images M1 formed in the second area A2 by emitting light toward the second area A2 and receiving light reflected from the second area A2.

More specifically, the second sensor 200 detects a specular reflection component and a diffuse reflection component included in the light reflected from a "portion with a mark image M1" in the second area A2, and a specular reflection component and a diffuse reflection component included in the light reflected from a "portion without a mark image M1" in the second area A2.

The mark images M1 used for detection by the detecting unit 10 are removed from the transfer belt 6 by a cleaning unit.

The detection result of the first sensor 100 is transmitted to the controller C1 via the first cable harness 130, the second sensor 200, and the second cable harness 230. The detection result of the second sensor 200 is transmitted to the controller C1 via the second cable harness 230.

Based on the detection results of the first sensor 100 and the second sensor 200, the controller C1 calculates the position and density of each of the mark images M1 formed in the first area A1 and the second area A2, and performs the density correction and the color shift correction.

### Specific Configuration of Detecting Unit

As illustrated in FIG. 3 to FIG. 7, the detecting unit 10 includes a sensor frame 170. The sensor frame 170 is a sheet metal member formed by, for example, punching or bending a steel plate. The sensor frame 170 extends in its longitudinal direction, which corresponds to the width direction of the transfer belt 6. As used herein, the longitudinal direction of the sensor frame 170 refers to the direction parallel to the longer sides of the sensor frame 170. A length of the sensor frame 170 in the longitudinal direction is greater than a length of the transfer belt 6 in the width direction. The longitudinal direction of the sensor frame 170 is an example of a particular direction of a detecting unit. For convenience, the longitudinal direction of the sensor frame 170, that is, the direction parallel to its longer sides and corresponding to the width direction of the transfer belt 6, may be referred to as the width direction of the sensor frame 170.

As illustrated in FIG. 3 to FIG. 5, fixing members 179 made of resin are attached to respective end portions of the sensor frame 170 on the first side and second side in the width direction of the sensor frame 170.

The end of the sensor frame 170 on the first side in the width direction of the sensor frame 170 is supported by a side frame located on the first side in the width direction of the main body 9, via the fixing member 179 located on the first side. The end on the second side in the width direction of the sensor frame 170 is supported by a side frame located on the second side in the width direction of the main body 9, via the fixing member 179 located on the second side.

The sensor frame 170 has a frame body 171, an upper bending portion 172, and a lower bending portion 173. The frame body 171 extends upward toward the rear, and also extends in the width direction. The upper bending portion 172 is bent and extends toward the rear from an upper-rear edge of the frame body 171. The upper bending portion 172 also extends in the width direction. The lower bending portion 173 is bent and extends downward toward the rear from a lower-front edge of the frame body 171. The lower bending portion 173 also extends in the width direction.

A ground wire 178 is mounted to a middle portion in the width direction of the sensor frame 170. The sensor frame 170 is grounded when the tip of the ground wire 178 protruding from the lower bending portion 173 comes into contact with a grounding path.

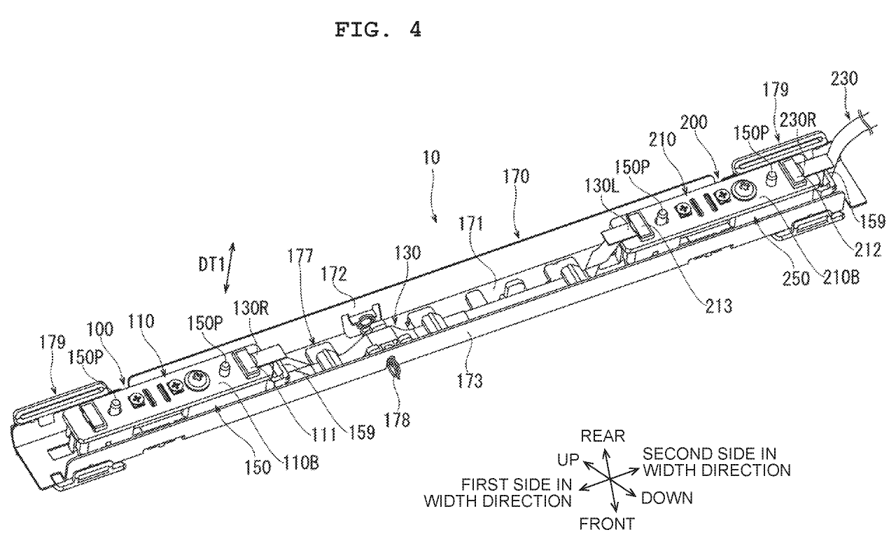

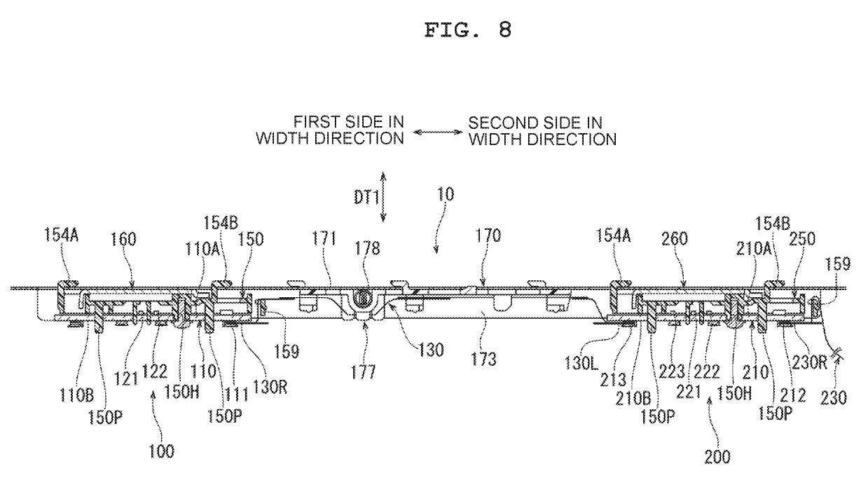

As illustrated in FIG. 1, the frame body 171 faces a lower-rear portion of the particular portion of the transfer belt 6, wound around the driving roller 61. The first sensor 100 and the second sensor 200 are located at the positions opposite to the transfer belt 6 with respect to the frame body 171. As illustrated in FIG. 4 and FIG. 8, the first sensor 100 and the second sensor 200 are mounted on the sensor frame 170.

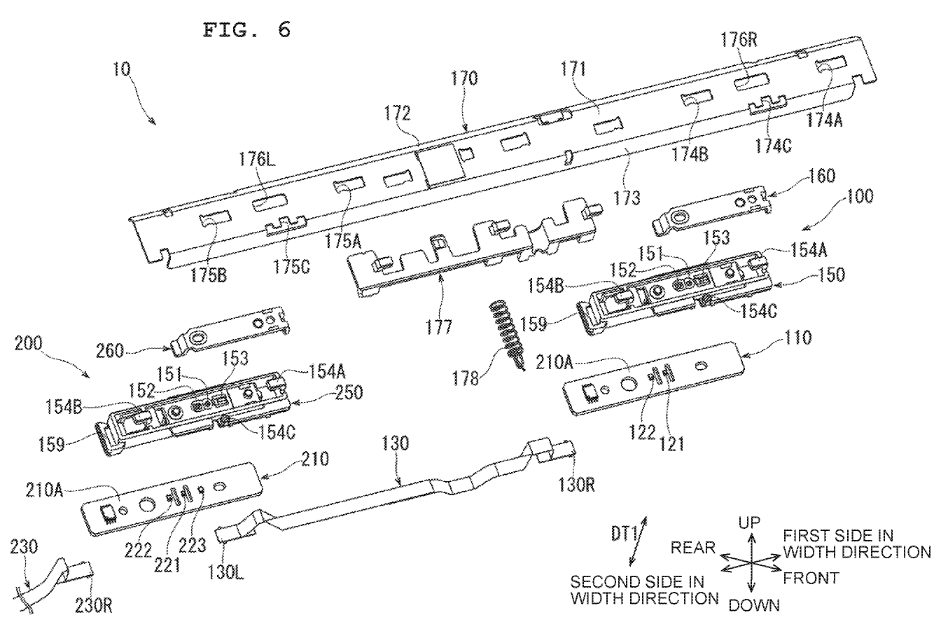

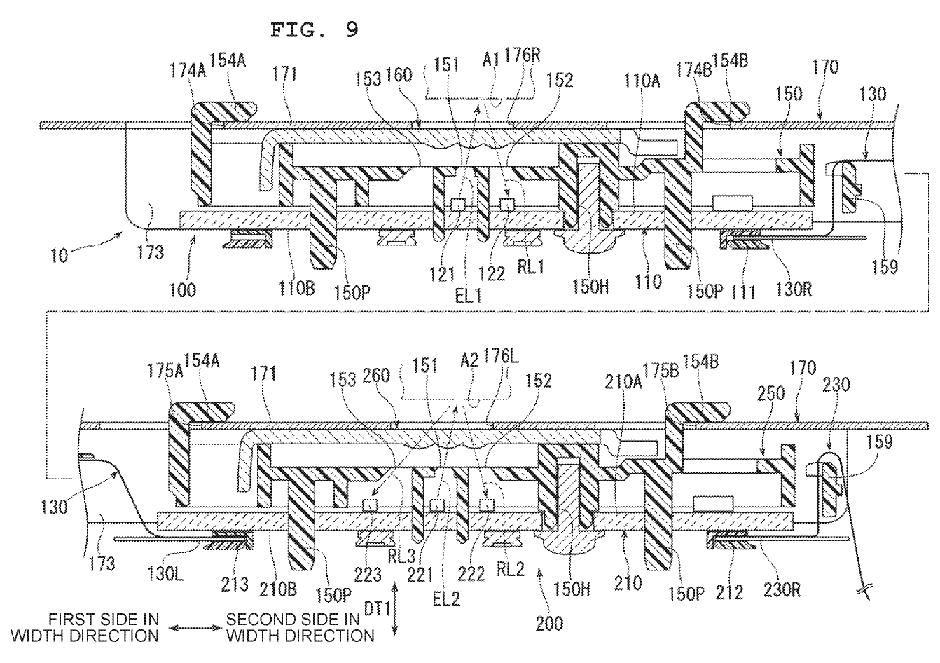

More specifically, as illustrated in FIG. 6 and FIG. 9, the first sensor 100 includes a first substrate 110, a first light-emitting element 121 (an example of a "first light emitter"), a first light-receiving element 122 (an example of a "first light receiver"), a first housing 150, and a transparent member 160. The second sensor 200 includes a second substrate 210, a second light-emitting element 221 (an example of a "second light emitter"), second light-receiving elements 222 and 223 (each an example of a "second light receiver"), a second housing 250, and a transparent member 260.

The first substrate 110 and the second substrate 210 are each a rectangular circuit board extending parallel to the frame body 171. A thickness direction of the first substrate 110 and a thickness direction of the second substrate 210 are the same direction, that is, a substrate thickness direction DT1. The substrate thickness direction DT1 is orthogonal to the frame body 171.

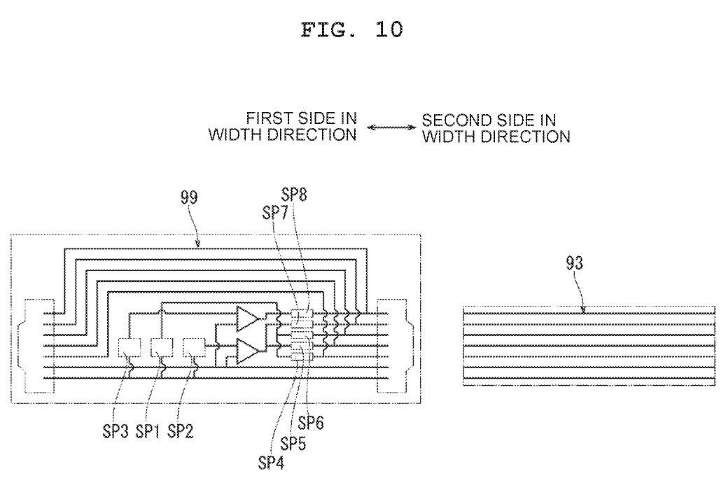

Each of the first substrate 110 and the second substrate 210 is a circuit board having a wiring pattern 99 illustrated in FIG. 10. Mounting positions SP1 to SP8 are set in the wiring pattern 99.

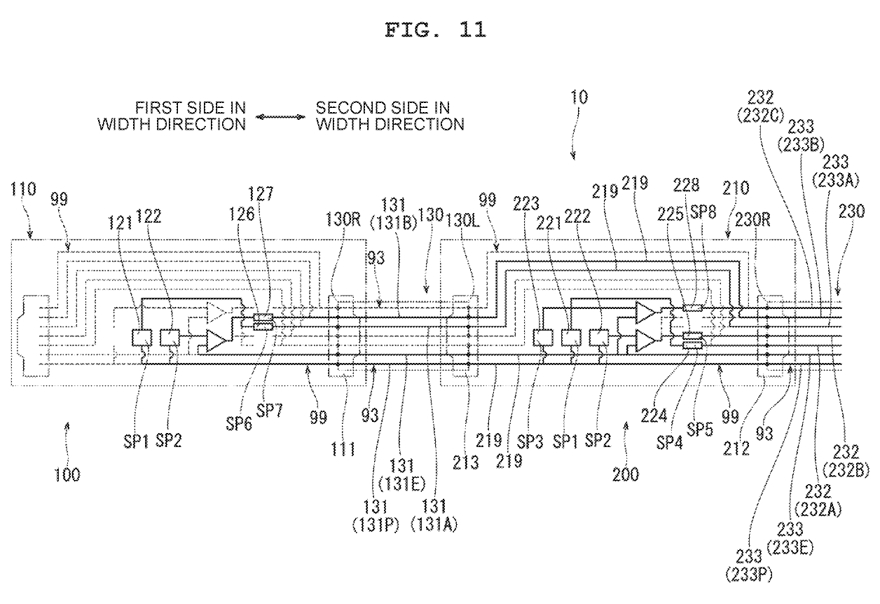

As illustrated in FIG. 11, in the wiring pattern 99 of the first substrate 110, the first light-emitting element 121 is mounted on the mounting position SP1, the first light-receiving element 122 is mounted on the mounting position SP2, and resistors 126 and 127 are mounted on the mounting positions SP6 and SP7, respectively. Consequently, in the wiring pattern 99 of the first substrate 110, the portions indicated by solid lines are enabled, while the portions indicated by dashed lines are disabled.

In the wiring pattern 99 of the second substrate 210, the second light-emitting element 221 is mounted on the mounting position SP1, the second light-receiving element 222 is mounted on the mounting position SP2, the second light-receiving element 223 is mounted on the mounting position SP3, and resistors 224, 225, and 228 are mounted on the mounting positions SP4, SP5, and SP8, respectively. Consequently, in the wiring pattern 99 of the second substrate 120, the portions indicated by solid lines are enabled, while the portions indicated by dashed lines are disabled.

The enabled portions in the wiring pattern 99 on the second substrate 210 include four relay wiring patterns 219.

The first light-emitting element 121 and the second light-emitting element 221 are, for example, LEDs. The first light-receiving element 122 and the second light-receiving elements 222, 223 are, for example, photodiodes sensitive respectively to the wavelengths of light emitted from the first light-emitting element 121 and the second light-emitting element 221.

As illustrated in FIG. 9, the first substrate 110 has a first surface 110A facing toward the frame body 171 and a second surface 110B facing in a direction opposite to the first surface 110A. The first light-emitting element 121 and the first light-receiving element 122 are disposed on the first surface 110A.

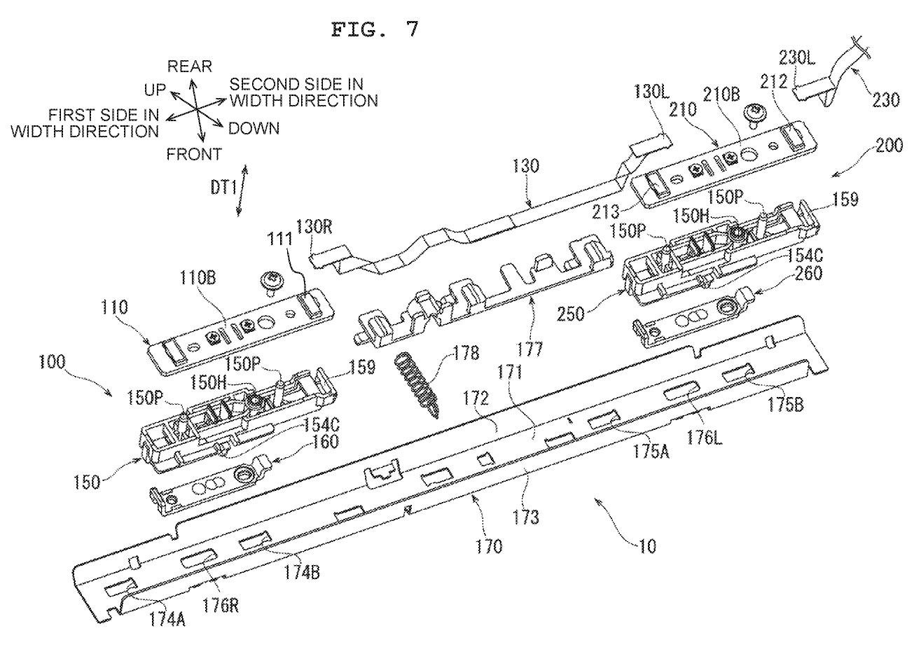

As illustrated in FIG. 7, the first substrate 110 has a first connector 111. The first connector 111 is disposed toward the edge on the second side in the width direction of the second surface 110B. As illustrated in FIG. 9, the first light-emitting element 121 and the first light-receiving element 122 are located on the first side in the width direction relative to the first connector 111.

As illustrated in FIG. 11, the enabled patterns in the wiring pattern 99 on the first substrate 110 extend to reach the first connector 111.

As illustrated in FIG. 9, the second substrate 210 has a first surface 210A facing toward the frame body 171 and a second surface 210B facing in a direction opposite to the first surface 210A. The second light-emitting element 221 and the second light-receiving elements 222 and 223 are disposed on the first surface 210A.

As illustrated in FIG. 7, the second substrate 210 has a second connector 212 and a third connector 213. The second connector 212 is disposed toward the end on the second side in the width direction of the second surface 210B. The third connector 213 is disposed toward the end on the first side in the width direction of the second surface 210B.

As illustrated in FIG. 9, the second light-emitting element 221 and the second light-receiving elements 222 and 223 are located on the first side in the width direction relative to the second connector 212 and on the second side in the width direction relative to the third connector 213.

As illustrated in FIG. 11, among the enabled patterns in the wiring pattern 99 on the second substrate 210, each of the relay wiring patterns 219 extends from the second connector 212 to the third connector 213, and wiring patterns different from the relay wiring patterns 219 extend to the second connector 212.

As illustrated in FIG. 7, the first housing 150 has two positioning pins 150P and a screw hole 150H on the surface facing the first surface 110A of the first substrate 110.

As illustrated in FIG. 9, the first substrate 110 is attached to the first housing 150 by inserting the positioning pins 150P into two respective positioning holes extending through the first substrate 110 and screwing a screw through the first substrate 110 into the screw hole 150H.

The first housing 150 covers substantially the entire first surface 110A. The first housing 150 is a resin molded part formed by, for example, injection molding of thermoplastic resin.

As illustrated in FIGS. 7 and 9, the first housing 150 has a first opening 151 and second openings 152 and 153. The first opening 151 and the second openings 152 and 153 are located on the surface of the first housing 150 facing the frame body 171 and each extend through the first housing 150 in the substrate thickness direction DT1.

The first opening 151 is located at the substantial center in the width direction of the first housing 150. The second opening 152 is located slightly away from the first opening 151 toward the second side in the width direction. The second opening 153 is located slightly away from the first opening 151 toward the first side in the width direction.

As illustrated in FIGS. 6 and 7, the first housing 150 has a cable harness holder 159. The cable harness holder 159 extends slightly from one of two corners located on the second side of the first housing 150 in the width direction toward the second side in the width direction, then bends and further extends toward the other of the two corners.

The transparent member 160 is a substantially rectangular, resin-molded part extending parallel to the frame body 171. The transparent member 160 is made of a resin material having high light transmittance.

As illustrated in FIG. 9, the transparent member 160 is attached to the surface facing the frame body 171 of the first housing 150 to cover the first opening 151 and the second openings 152 and 153. In the transparent member 160, a portion covering the first opening 151, a portion covering the second opening 152, and a portion covering the third opening 153 each have a lens-shape.

As illustrated in FIG. 6, the first housing 150 has engagement portions 154A, 154B, and 154C. The frame body 171 has engagement-receiving portions 174A, 174B, and 174C near the end on the first side in the width direction.

As illustrated in FIG. 3, the first housing 150 is attached to the frame body 171 by the engagement between the engagement portions 154A, 154B, and 154C and the engagement-receiving portions 174A, 174B, and 174C, respectively, and the first substrate 110 is attached to the frame body 171 via the first housing 150.

As illustrated in FIG. 6 and FIG. 9, a rectangular frame opening 176R extends through the frame body 171 at a position facing the first opening 151 and the second openings 152, 153 of the first housing 150.

As illustrated in FIG. 6 and FIG. 7, the second housing 250 is the same component as the first housing 150. Therefore, the same reference numerals used in the description of the first housing 150 are also used for the second housing 250, and description for those same components will be omitted.

As illustrated in FIG. 9, the second substrate 210 is attached to the second housing 250 by inserting two positioning pins 150P into two respective positioning holes extending through the second substrate 210, and screwing a screw through the second substrate 210 into a screw hole 150H. The second housing 250 covers substantially the entire first surface 210A.

As illustrated in FIG. 7 and FIG. 9, the second housing 250 has a first opening 151 and second openings 152, 153. As illustrated in FIG. 6 and FIG. 7, the second housing 250 has a cable harness holder 159.

The transparent member 260 is the same component as the transparent member 160. As illustrated in FIG. 9, the transparent member 260 is attached to the surface of the second housing 250 facing the frame body 171 to cover the first opening 151 and the second openings 152 and 153 of the second housing 250.

As illustrated in FIG. 6, the second housing 250 has engagement portions 154A, 154B, and 154C. The frame body 171 has engagement-receiving portions 175A, 175B, and 175C near the end on the second side in the width direction.

As illustrated in FIG. 3, the second housing 250 is attached to the frame body 171 by the engagement between the engagement portions 154A, 154B, and 154C and the engagement-receiving portions 175A, 175B, and 175C, respectively, and the second substrate 210 is attached to the frame body 171 via the second housing 250.

As illustrated in FIGS. 6 and 9, the frame body 171 has a rectangular frame opening 176L extending therethrough at a position corresponding to the first opening 151 and the second openings 152, 153 of the second housing 250.

The first cable harness 130 and the second cable harness 230 are flexible flat cables each having seven wires 93 illustrated in FIG. 10.

As illustrated in FIG. 11, a first end 130R of the first cable harness 130 is connected to the first connector 111 disposed on the second surface 110B of the first substrate 110. Thus, the enabled patterns in the wiring pattern 99 on the first substrate 110 are connected to the first end 130R of the first cable harness 130 via the first connector 111.

A second end 130L of the first cable harness 130 is connected to the third connector 213 disposed on the second surface 210B of the second substrate 210. Thus, the enabled patterns in the wiring patterns 99 on the second substrate 210 are connected to the second end 130L of the first cable harness 130 via the third connector 213.

Thus, four wires 93 of the first cable harness 130 indicated by solid lines are enabled, while three wires 93 of the first cable harness 130 indicated by dashed lines are disabled. The four wires 93 enabled in the first cable harness 130 are first wires 131. The four first wires 131 include first wires 131P, 131E, 131A, and 131B. The first wire 131P is a power supply wire. The first wire 131E is a ground wire. The first wires 131A and 131B are signal wires for the first sensor 100. The first wires 131A and 131B are an example of "a plurality of first wires corresponding to a first sensor".

As illustrated in FIG. 4, an inserting direction of the first end 130R of the first cable harness 130 to the first connector 111 is orthogonal to the substrate thickness direction DT1 and is oriented toward the first side in the width direction.

An inserting direction of the second end 130L of the first cable harness 130 to the third connector 213 is orthogonal to the substrate thickness direction DT1 and is oriented toward the second side in the width direction.

As illustrated in FIG. 9, the first cable harness 130, extending from the second surface 110B, across the first substrate 110, and beyond the first surface 110A, is in contact with the cable harness holder 159 of the first housing 150 while being bent in a substantially "L" shape. Thus, the cable harness holder 159 of the first housing 150 holds the first cable harness 130. Furthermore, the cable harness holder 159 of the first housing 150 reduces the occurrence of detachment of the first end 130R of the first cable harness 130 from the first connector 111.

As illustrated in FIGS. 4 and 7, a first cable harness guide 177 is attached to the frame body 171 at a position between the first sensor 100 and the second sensor 200. The first cable harness guide 177 guides and holds the first cable harness 130 extending from the first connector 111 to the third connector 213 with multiple bends.

As illustrated in FIG. 11, a first end 230R of the second cable harness 230 is connected to the second connector 212 disposed on the second surface 210B of the second substrate 210. Thus, the enabled patterns in the wiring pattern 99 on the second substrate 210 are connected to the first end 230R of the second cable harness 230 via the second connector 212.

As illustrated in FIG. 2, a second end 230L of the second cable harness 230 can be connected to the controller C1 via an unillustrated connector disposed on the control board CB.

Thus, as illustrated in FIG. 11, seven wires 93 indicated by solid lines in the second cable harness 230 are enabled. The seven wires 93 enabled in the second cable harness 230 include three second wires 232, and four third wires 233 corresponding respectively to the four first wires 131. The three second wires 232 include second wires 232A, 232B, and 232C that are signal wires for the second sensor 200. The four third wires 233 include third wires 233P, 233E, 233A, and 233B. The third wire 233P is a power supply wire and corresponds to the first wire 131P. The third wire 233E is a ground wire and corresponds to the first wire 131E. The third wires 233A and 233B are signal wires for the first sensor 100 and correspond to the first wires 131A and 131B, respectively. The three second wires 232 are an example of "a plurality of wires corresponding to a second sensor", and the third wires 233A and 233B are an example of "a plurality of second wires corresponding to a first sensor".

Each of the relay wiring patterns 219 electrically connects a first wire 131 and a corresponding third wire 233 via the second connector 212 and the third connector 213.

As illustrated in FIG. 4, an inserting direction of the first end 230R of the second cable harness 230 to the second connector 212 is orthogonal to the substrate thickness direction DT1 and is oriented toward the first side in the width direction.

As illustrated in FIG. 9, the second cable harness 230, extending from the second surface 210B, across the second substrate 210,and beyond the first surface 210A, is in contact with the cable harness holder 159 of the second housing 250 while being bent in a substantially "U" shape. Thus, the cable harness holder 159 of the second housing 250 holds the second cable harness 230. The cable harness holder 159 of the second housing 250 reduces occurrence of detachment of the first end 230R of the second cable harness 230 from the second connector 212.

In the first sensor 100, the first light-emitting element 121 emits light EL1 toward the first area A1. The light EL1 reaches the first area A1 through the first opening 151 of the first housing 150, the transparent member 160, and the frame opening 176R, and is reflected from the first area A1.

A reflected light RL1, which is reflected from the first area A1, is received by the first light-receiving element 122 through the frame opening 176R, the transparent member 160, and the second opening 152 of the first housing 150. More specifically, the first light-receiving element 122 receives the specular reflection component of the light reflected from the first area A1.

The first sensor 100 detects the mark images M1 formed in the first area A1 based on the reflected light RL1 received by the first light-receiving element 122.

In the second sensor 200, the second light-emitting element 221 emits light EL2 toward the second area A2. The light EL2 reaches the second area A2 through the first opening 151 of the second housing 250, the transparent member 260, and the frame opening 176L, and is reflected from the second area A2.

A reflected light RL2, which is reflected from the second area A2, is received by the second light-receiving element 222 through the frame opening 176L, the transparent member 260, and the second opening 152 of the second housing 250. More specifically, the second light-receiving element 222 receives the specular reflection component of the light reflected from the second area A2.

A reflected light RL3, which is reflected from the second area A2, is received by the second light-receiving element 223 through the frame opening 176L, the transparent member 260, and the second opening 153 of the second housing 250. More specifically, the second light-receiving element 223 receives the diffuse reflection component of the light reflected from the second area A2.

The second sensor 200 detects the mark images M1 formed in the second area A2 based on the reflected light RL2 and RL3 received by the second light-receiving elements 222 and 223.

### Effect

In the detecting unit 10 of the embodiment, as illustrated in FIG. 11, each relay wiring pattern 219 formed on the second substrate 210 connects a first wire 131 of the first cable harness 130 and a corresponding third wire 233 of the second cable harness 230, thereby relaying the detection result of the first sensor 100. Thus, the first cable harness 130 can be shortened in the detecting unit 10. Consequently, the total length of the first cable harness 130 and the second cable harness 230 can be shortened in the detecting unit 10.

Therefore, with the detecting unit 10 of the embodiment, the routing operation of the first cable harness 130 and the second cable harness 230 can be simplified, and parts costs can be reduced.

In the image forming apparatus 1 of the embodiment, the routing operation of the first cable harness 130 and the second cable harness 230 can also be simplified, and parts costs can also be reduced.

In the detecting unit 10, as illustrated in FIG. 4, the first substrate 110 has the first connector 111 connected to the first end 130R of the first cable harness 130. The second substrate 210 has the second connector 212 connected to the first end 230R of the second cable harness 230, and the third connector 213 connected to the second end 130L of the first cable harness 130. As illustrated in FIG. 11, the relay wiring patterns 219 extend from the second connector 212 to the third connector 213. With the detecting unit 10 using the first connector 111, the second connector 212, and the third connector 213, the routing operation of the first cable harness 130 and the second cable harness 230 can be further simplified.

In the detection unit 10, as illustrated in FIG. 9, the first sensor 100 has the first light-emitting element 121 and the first light-receiving element 122 disposed on the first substrate 110. The second sensor 200 has the second light-emitting element 221 and the second light-receiving elements 222 and 223 disposed on the second substrate 210. The first light-emitting element 121 and the first light-receiving element 122 are located on the first side in the width direction relative to the first connector 111. The second light-emitting element 221 and the second light-receiving elements 222 and 223 are located on the first side in the width direction relative to the second connector 212 and on the second side in the width direction relative to the third connector 213. With this configuration, the first end 130R of the first cable harness 130 can be connected to the first connector 111 without bypassing the first light-emitting element 121 and the first light-receiving element 122. Similarly, the second end 130L of the first cable harness 130 can be connected to the third connector 213 without bypassing the second light-emitting element 221 and the second light-receiving elements 222 and 223. As a result, in the detection unit 10, the first cable harness 130 can be further shortened. Further, with this configuration, the first end 230R of the second cable harness 230 can be connected to the second connector 212 without bypassing the second light-emitting element 221 and the second light-receiving elements 222 and 223. As a result, in the detection unit 10, the second cable harness 230 can also be shortened.

In the detection unit 10, as illustrated in FIG. 4, the inserting direction of the first end 130R of the first cable harness 130 into the first connector 111 is orthogonal to the substrate thickness direction DT1 and is oriented toward the first side in the width direction. The inserting direction of the first end 230R of the second cable harness 230 into the second connector 212 is orthogonal to the substrate thickness direction DT1 and is oriented toward the first side in the width direction. The inserting direction of the second end 130L of the first cable harness 130 into the third connector 213 is orthogonal to the substrate thickness direction DT1 and is oriented toward the second side in the width direction. With this configuration, the first connector 111, the second connector 212, the third connector 213, the first cable harness 130, and the second cable harness 230 does not occupy excessive space in the substrate thickness direction DT1. As a result, the detection unit 10 can be reduced in size in the substrate thickness direction DT1. Furthermore, with this configuration, the first cable harness 130 and the second cable harness 230 can be further shortened.

In the detecting unit 10, the first cable harness 130 and the second cable harness 230 are flexible flat cables. Thus, the first connector 111, the second connector 212, the third connector 213, the first cable harness 130, and the second cable harness 230 occupy further less space in the substrate thickness direction DT1. As a result, the detecting unit 10 can be further reduced in size in the substrate thickness direction DT1.

In the detecting unit 10, as illustrated in FIG. 9, the first substrate 110 has the first surface 110A on which the first light-emitting element 121 and the first light-receiving element 122 are disposed, and the second surface 110B which faces in a direction opposite to the first surface 110A and to which the first cable harness 130 is connected. With this configuration, the first surface 110A and the second surface 110B of the first substrate 110 can be used efficiently, and consequently the first substrate 110 can be reduced in size.

In the detecting unit 10, the second substrate 210 has the first surface 210A on which the second light-emitting element 221 and the second light-receiving elements 222 and 223 are disposed, and the second surface 210B which faces in a direction opposite to the first surface 210A and to which the first cable harness 130 and the second cable harness 230 are connected. With this configuration, the first surface 210A and the second surface 210B of the second substrate 210 can be used effectively, and consequently the second substrate 210 can be reduced in size.

In the detecting unit 10, the first sensor 100 has the first housing 150 covering the first surface 110A of the first substrate 110. The light EL1, which is emitted from the first light-emitting element 121 toward the first area A1, passes through the first opening 151 of the first housing 150. The reflected light RL1, which is reflected from the first area A1 and received by the first light-receiving element 122, passes through the second opening 152 of the first housing 150. With the configuration in which the first opening 151 and the second opening 152 are provided in the first housing 150, unnecessary light can be blocked in the detecting unit 10, thereby improving a signal-to-noise (S/N) ratio of the first sensor 100.

In the detecting unit 10, the second sensor 200 has a second housing 250 covering the surface 210A of the second substrate 210. The light EL2, which is emitted from the second light-emitting element 221 toward the second area A2, passes through the first opening 151 of the second housing 250. The reflected light RL2, which is reflected from the second area A2 and received by the second light-receiving element 222, passes through the second opening 152 of the second housing 250. The reflected light RL3, which is reflected from the second area A2 and received by the second light-receiving element 223, passes through the second opening 153 of the second housing 250. With the configuration in which the first opening 151 and the second openings 152 and 153 are provided in the second housing 250, unnecessary light can be blocked in the detecting unit 10, thereby improving an S/N ratio of the second sensor 200.

In the detecting unit 10, the first housing 150 has the cable harness holder 159 that holds the first cable harness 130 extending from one side of the first substrate 110 in which the second surface 110B is located to the other side of the first substrate 110 in which the first surface 110A is located. In the detecting unit 10, the cable harness holder 169 of the first housing 150 can reduce a tendency of the first cable harness 130, which extends from the one side of the first substrate 110 in which the second surface 110B is located to the other side of the first substrate 110 in which the first surface 110A is located, to move back toward the one side of the first substrate 110. Thus, the routing operation of the first cable harness 130 can be further simplified.

In the detecting unit 10, the second housing 250 has the cable harness holder 159 that holds the second cable harness 230 extending from one side of the second substrate 210 in which the second surface 210B is located to the other side of the second substrate 210 in which the first surface 210A is located. In the detecting unit 10, the cable harness holder 159 can reduce movement of the second cable harness 230, which extends from the one side in which the back surface 210B is located to the other side in which the first surface 210A is located, back to the one side of the second substrate 210. Thus, the routing operation of the second cable harness 230 can be further simplified.

As illustrated in FIG. 2 and FIG. 4, the detecting unit 10 includes the sensor frame 170 that extends in the width direction and to which the first sensor 100 and the second sensor 200 are mounted. With this configuration, the positional relationship between the first sensor 100 and the second sensor 200 can be defined accurately.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

In the above embodiment, the image forming apparatus of the present disclosure is embodied as the image forming apparatus 1 with an image forming function. However, the present disclosure is not limited to such configuration. For example, the configuration of the present disclosure may be applied to a multi-function peripheral with both an image forming function and an image reading function.

Although the image carrier is embodied as the transfer belt 6 in the above embodiment, the present disclosure is not limited to such configuration. For example, a configuration in which the image carrier is a photosensitive drum is also included within the present disclosure.

Although the first sensor 100 has a single first light-receiving element 122 in the above embodiment, the present disclosure is not limited to such configuration. For example, the first sensor may have two first light-receiving elements.

Although the second sensor 200 has two second light-receiving elements 222 and 223 in the above embodiment, the present disclosure is not limited to such configuration. For example, the first sensor may have a single second light-receiving element.

What is claimed is:

1. A detecting unit for an image forming apparatus configured to form a toner image on an image carrier, the detecting unit comprising:
a first sensor including a first substrate, the first sensor being disposed on a first side in a particular direction of the detecting unit, the particular direction corresponding to a width direction of the image carrier;
a second sensor including a second substrate, the second sensor being disposed on a second side, which is opposite to the first side, in the particular direction;
a first cable harness including a plurality of first wires corresponding to the first sensor; and
a second cable harness including:
a plurality of second wires corresponding to the first sensor; and
a plurality of wires corresponding to the second sensor, wherein:
the first sensor is configured to detect a mark image formed in a first area of the image carrier by emitting a first light to the first area and receiving the first light reflected from the first area, the first area being located on a first side in the width direction of the image carrier;
the second sensor is configured to detect a mark image formed in a second area of the image carrier by emitting a second light to the second area and receiving the second light reflected from the second area, the second area being located on a second side, opposite to the first side, in the width direction of the image carrier;
the first cable harness has a first end and a second end opposite to each other, the first end of the first cable harness being connected to the first substrate, and the second end of the first cable harness being connected to the second substrate;
the second cable harness has a first end and a second end opposite to each other, the first end of the second cable harness being connected to the second substrate, and the second end of the second cable harness being connectable to a controller of the image forming apparatus; and
the second substrate includes a plurality of relay wiring patterns connecting the plurality of first wires and the plurality of second wires.

2. The detecting unit according to claim 1, wherein:
the first substrate has a first connector to which the first end of the first cable harness is connected;
the second substrate has a second connector to which the first end of the second cable harness is connected, and a third connector to which the second end of the first cable harness is connected; and
each of the plurality of relay wiring patterns extends from the second connector to the third connector.

3. The detecting unit according to claim 2, wherein:
the first sensor includes:
a first light emitter disposed on the first substrate and configured to emit the first light to the first area; and
a first light receiver disposed on the first substrate and configured to receive the first light reflected from the first area;
the second sensor includes:
a second light emitter disposed on the second substrate and configured to emit the second light to the second area; and
a second light receiver disposed on the second substrate and configured to receive the second light reflected from the second area;
the first light emitter and the first light receiver are located on the first side in the particular direction relative to the first connector; and
the second light emitter and the second light receiver are located on the first side in the particular direction relative to the second connector, and located on the second side in the particular direction relative to the third connector.

4. The detecting unit according to claim 3, wherein:
an inserting direction of the first end of the first cable harness to the first connector is orthogonal to a thickness direction of the first substrate and is oriented toward the first side in the particular direction;
an inserting direction of the first end of the second cable harness to the second connector is orthogonal to a thickness direction of the second substrate and is oriented toward the first side in the particular direction; and
an inserting direction of the second end of the first cable harness to the third connector is orthogonal to the thickness direction of the second substrate and is oriented toward the second side in the particular direction.

5. The detecting unit according to claim 4, wherein each of the first cable harness and the second cable harness is a flexible flat cable.

6. The detecting unit according to claim 1, wherein:
the first sensor includes:
a first light emitter configured to emit the first light to the first area; and
a first light receiver configured to receive the first light reflected from the first area; and
the first substrate has:
a first surface on which the first light emitter and the first light receiver are disposed; and
a second surface facing in a direction opposite to the first surface, and to which the first cable harness is connected.

7. The detecting unit according to claim 1, wherein:
the first sensor includes:
a first light emitter configured to emit the first light to the first area; and
a first light receiver configured to receive the first light reflected from the first area; and
the first substrate has a first surface on which the first light emitter and the first light receiver are disposed; and
the first sensor includes a first housing that covers the first surface, the first housing having:
a first opening that allows the first light emitted from the first light emitter toward the first area to pass through the first opening; and
a second opening that allows the first light reflected from the first area to pass through the second opening prior to the reflected first light reaching the first light receiver.

8. The detecting unit according to claim 7, wherein:
the first substrate has a second surface facing in a direction opposite to the first surface, and to which the first cable harness is connected; and
the first housing has a cable harness holder configured to hold the first cable harness extending from the second surface, across the first substrate, and beyond the first surface.

9. The detecting unit according to claim 1, further comprising a sensor frame extending in the particular direction, and on which the first sensor and the second sensor are mounted.

10. An image forming apparatus comprising:
a photosensitive drum;
a developing roller;
a belt on which a toner image is to be formed by the photosensitive drum;
a control board;
a first sensor including a first substrate, the first sensor being disposed facing a first area of the belt, the first area being located on a first side in a width direction of the belt;
a second sensor including a second substrate, the second sensor being disposed facing a second area of the belt, the second area being located on a second side, opposite to the first side, in the width direction of the belt;
a first cable harness including a plurality of first wires corresponding to the first sensor, the first cable harness having a first end and a second end opposite to each other, the first end of the first cable harness being connected to the first substrate, the second end of the first cable harness being connected to the second substrate; and
a second cable harness including:
a plurality of second wires corresponding to the first sensor; and
a plurality of wires corresponding to the second sensor, the second cable harness having a first end and a second end opposite to each other, the first end of the second cable harness being connected to the second substrate, the second end of the second cable harness being connected to the control board of the image forming apparatus, wherein:
the first sensor is configured to detect a mark image formed in the first area by emitting a first light to the first area and receiving the first light reflected from the first area;
the second sensor is configured to detect a mark image formed in the second area by emitting a second light to the second area and receiving the second light reflected from the second area; and
the second substrate includes a plurality of relay wiring patterns connecting the plurality of first wires and the plurality of second wires.

11. The image forming apparatus according to claim 10, wherein:
the first substrate has a first connector to which the first end of the first cable harness is connected;
the second substrate has a second connector to which the first end of the second cable harness is connected, and a third connector to which the second end of the first cable harness is connected; and
each of the plurality of relay wiring patterns extends from the second connector to the third connector.

12. The image forming apparatus according to claim 11, wherein:
the first sensor includes:
a first light emitter disposed on the first substrate and configured to emit the first light to the first area; and
a first light receiver disposed on the first substrate and configured to receive the first light reflected from the first area;
the second sensor includes:
a second light emitter disposed on the second substrate and configured to emit the second light to the second area; and
a second light receiver disposed on the second substrate and configured to receive the second light reflected from the second area;
the first light emitter and the first light receiver are located on the first side in the width direction of the belt relative to the first connector; and
the second light emitter and the second light receiver are located on the first side in the width direction of the belt relative to the second connector, and located on the second side in the width direction of the belt relative to the third connector.

13. The image forming apparatus according to claim 12, wherein:
an inserting direction of the first end of the first cable harness to the first connector is orthogonal to a thickness direction of the first substrate and is oriented toward the first side in the width direction of the belt;
an inserting direction of the first end of the second cable harness to the second connector is orthogonal to a thickness direction of the second substrate and is oriented toward the first side in the width direction of the belt; and
an inserting direction of the second end of the first cable harness to the third connector is orthogonal to the thickness direction of the second substrate and is oriented toward the second side in the width direction of the belt.

14. The image forming apparatus according to claim 13, wherein each of the first cable harness and the second cable harness is a flexible flat cable.

15. The image forming apparatus according to claim 10, wherein:
the first sensor includes:
a first light emitter configured to emit the first light to the first area; and
a first light receiver configured to receive the first light reflected from the first area; and
the first substrate has:
a first surface on which the first light emitter and the first light receiver are disposed; and
a second surface, facing in a direction opposite to the first surface, to which the first cable harness is connected.

16. The image forming apparatus according to claim 10, wherein:
the first sensor includes:
a first light emitter configured to emit the first light to the first area; and
a first light receiver configured to receive the first light reflected from the first area; and
the first substrate has a first surface on which the first light emitter and the first light receiver are disposed; and
the first sensor includes a first housing that covers the first surface, the housing having:
a first opening that allows the first light emitted from the first light emitter toward the first area to pass through the first opening; and
a second opening that allows the first light reflected from the first area to pass through the second opening prior to the reflected first light reaching the first light receiver.

17. The image forming apparatus according to claim 16, wherein:
the first substrate has a second surface, facing in a direction opposite to the first surface, and to which the first cable harness is connected; and
the first housing has a cable harness holder holding the first cable harness extending from the second surface, across the first substrate, and beyond the first surface.

18. The image forming apparatus according to claim 10, further comprising a sensor frame extending in the width direction, and on which the first sensor and the second sensor are mounted.
